(19) United States
(12) Patent Application Publication
(10) Pub. No.: US 2018/0055710 A1
(43) Pub. Date: Mar. 1, 2018

(54) Flexible Ankle-Based Inversion Device

(71) Applicant: Adam Jon Zbinden, Tualatin, OR (US)

(72) Inventor: Adam Jon Zbinden, Tualatin, OR (US)

(21) Appl. No.: 15/249,438

(22) Filed: Aug. 28, 2016

(51) Int. Cl. A61H 1/00; A63B 21/00

(52) U.S. Cl. CPC A61H 1/006; A61H 2205/106; A63B 21/4015

(57) ABSTRACT

This document presents a design for an ankle-based inversion device which can be constructed entirely from webbing. All individual design components are described in detail, and complete instructions for use and assembly are provided.

### BACKGROUND OF THE INVENTION

In recent decades, inversion therapy has become a popular and well-researched method for achieving musculoskeletal decompression.

Using the lower-leg as the point of suspension enables nearly every joint in the human body to be in a state of traction.

Devices for achieving this physical posture have been available for several decades, marketed under the popular name of “gravity boots”.

These conventional designs use rigid metal or plastic shells which clamp or cinch around the user's shins, and a hook which is secured to the front of the shell allows for attachment to a horizontal supporting bar structure.

The device described in this document provides an alternative method for performing this exercise, with design advantages resulting in improved safety and comfort.

### SUMMARY OF THE INVENTION

The device described in this document tightens and secures around the user's lower leg in direct proportion to the magnitude of applied tension. In practice, this means that the device is in a state of maximum closure when the user is fully inverted. It is therefore impossible to slip out of the device while using it.

The materials used to construct the device are soft and flexible, and conform to the shape of the user's leg to distribute pressure as evenly as possible and therefor minimize discomfort. Traditional rigid-shell designs place concentrated pressure on the front of the user's lower shin region during use, and other pressure points can exist due to the metal hooks or buckles required by conventional designs.

The design shown in this document is collapsible for storage and transport, and can easily fit into a small gym bag. Traditional gravity boots can be oversized and heavy, and are less portable.

The additional weight attached to the ankles when using conventional gravity boots creates a significant burden when raising the feet to the bar elevation to attach the hooks. This burden is caused by the natural moment which occurs when the feet are extended outward in front of the body and pivoted about the axis of the hips and lower abdomen. The gravitational loading which is caused by the weight of the attached conventional gravity boots is multiplied by the length of the entire leg, resulting in an additional force which must be overcome by muscular effort. The design of the device described in this document eliminates this unnecessary burden, as no extra weight is attached to the ankles when entering or exiting the inverted posture.

While the device described enables decompression of the spine and joints, said device can also be used as a fitness tool. Exercises which can be performed while in the inverted posture include:
1) Sit-ups
2) Reverse crunches and back extensions
3) Reverse squats, an exercise functionally equivalent to a full glute-ham raise

### BRIEF DESCRIPTION OF THE DRAWINGS

FIG. 1 is a detailed drawing of the device, with leaders and numbers corresponding to the individual components which are described in the claims section.

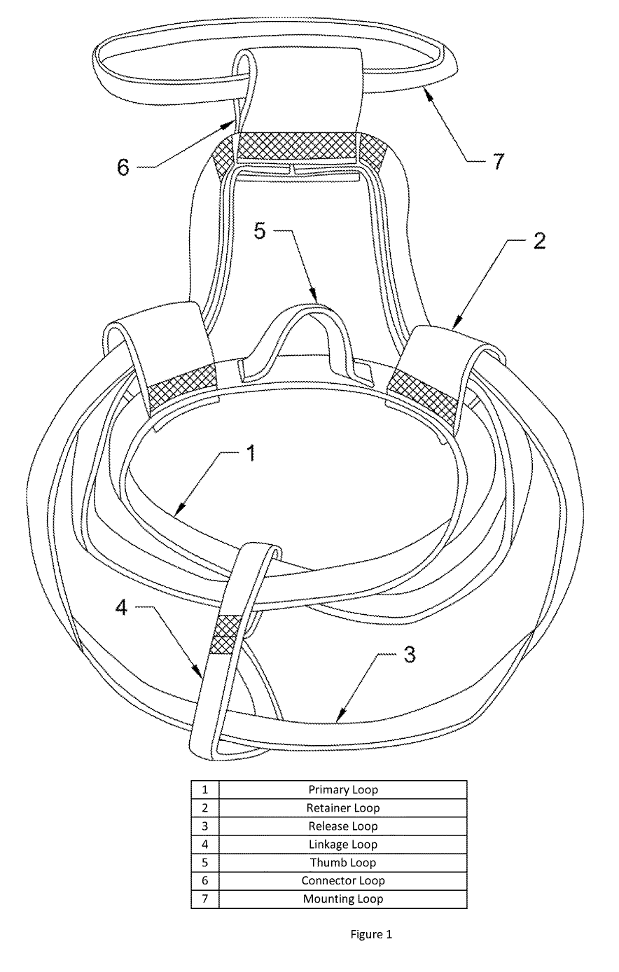

FIG. 2 depicts the spatial relationships between the horizontal support structure, the device, and the user's legs.

FIG. 3 shows the potential for replacing the connector loop with a hardware ring while still meeting the functional design requirements of the connector loop component.

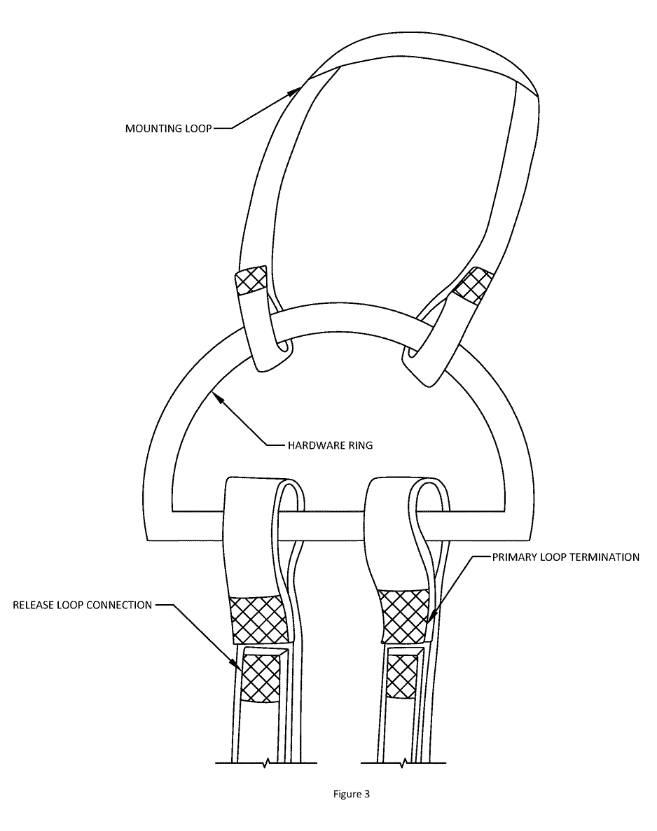

FIG. 4 is a black and white photograph of a working test model, assembled according to the design described in the claims section.

FIG. 5 presents a flattened sketch of the topology of the device, viewed from the front as it appears when facing the user.

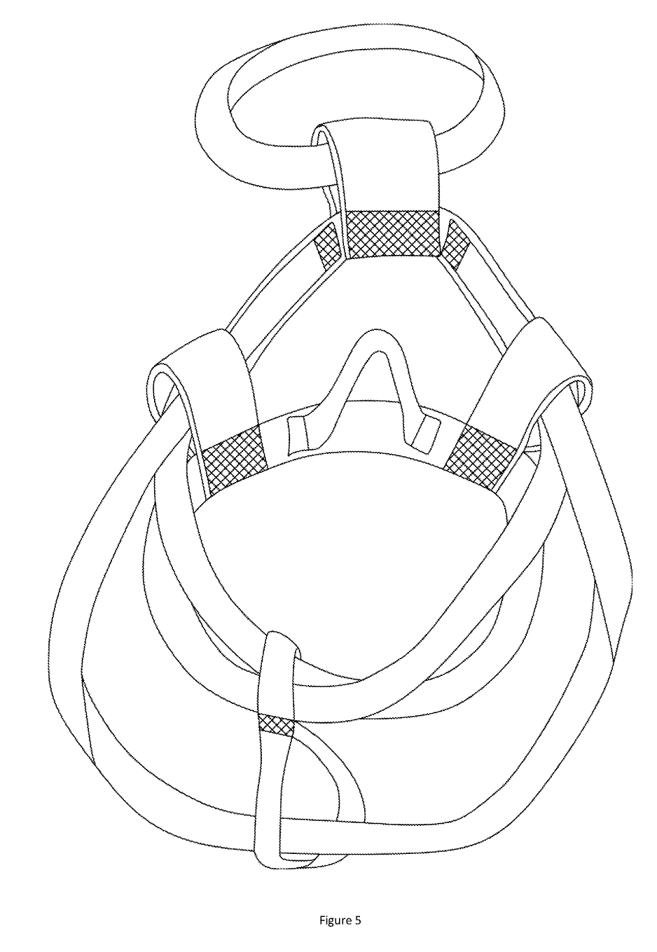

### DETAILED DESCRIPTION OF THE INVENTION

Directions for Use:

*It is highly recommended to cover the ankle area with a protective layer (such as cotton sweat bands, neoprene sleeves, or socks with open toe-boxes) before using the device, and to never directly interface the device with exposed skin. *When raising the upper-body to gain a hand-hold on the mounting bar, an attachment which is at a lower elevation than the bar itself (such as a rope or handle which connects to the bar) may be used to “climb” upward and decrease the required reaching distance.

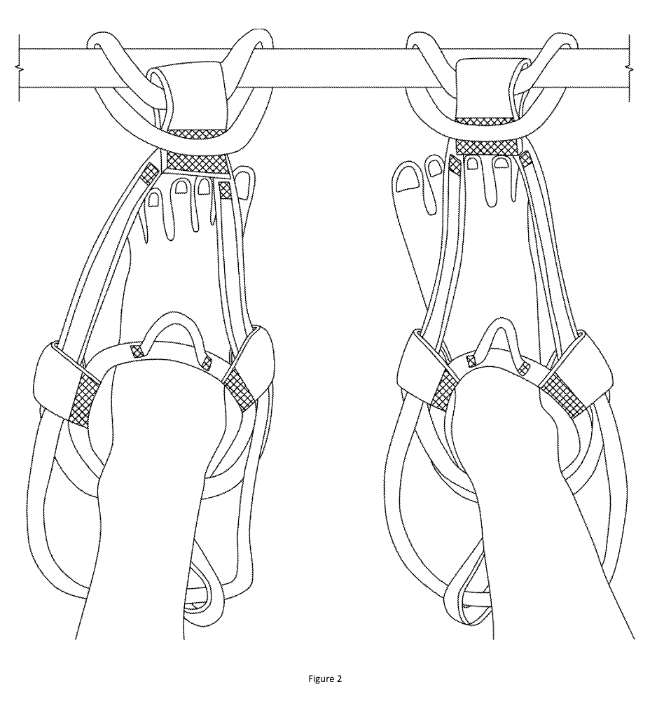

Entry:
1) Place the mounting loop of one device over the mounting bar, and thread the rest of the device through it to encircle the bar within the mounting loop, as shown in FIG. 2. Repeat for the second device. The devices should be oriented so that the bowed region of the retainer loops face away from the user (as depicted in the figures).
2) Space the devices apart to a comfortable distance (slightly less than shoulder width).
3) Expand each primary loop to its maximum circumference, and place the thumb of each hand through the thumb loop of the corresponding device in order to hold the primary loop open. With the other four fingers of each hand, grip the horizontal support bar on the outside of each device.
4) Lift both feet upward to the bar, and insert each foot through its corresponding device until the primary loop is loosely surrounding the lower shin region, just above the ankle.
5) Move both feet downward in order to tension and close the primary loop around the ankle. This secures the connection between the device and the user.
6) Release the manual grip on the support bar, and lean back into the inverted position.

Exit:
1) Raise the torso upward until the bar is within reach, and establish a secure hold on the bar with both hands to support body weight.*
2) Move one foot upward, and exert downward tension on the release loop of its surrounding device with the opposite foot. This process expands and de-tensions the primary loop. Withdraw the leg and foot from the inversion device which has now been opened.
3) Repeat Step 2 for the leg which has not yet been released from its inversion device.
4) Lower both feet to the ground and establish secure footing and balance before releasing the hands from the bar.

Directions for Assembly:

The device can be assembled based on the figures and claims provided in this document, using standard best practices for sewing webbing for load-bearing applications.

Attach the retainer loops to the primary loop webbing first, then close the primary loop by threading each end of its webbing through the opposite retainer loop and terminating said ends at the connector loop. This creates the functional topology of the device, after which the auxiliary components listed in the claims may be attached.

It is important to note that the retainer loops and the connector loop envelope both sides of the webbing which they are attached to.

For production models, it may be useful to cover areas which are exposed to contact abrasion from friction (such as the retainer loops and the mounting loop) with material sheaths.

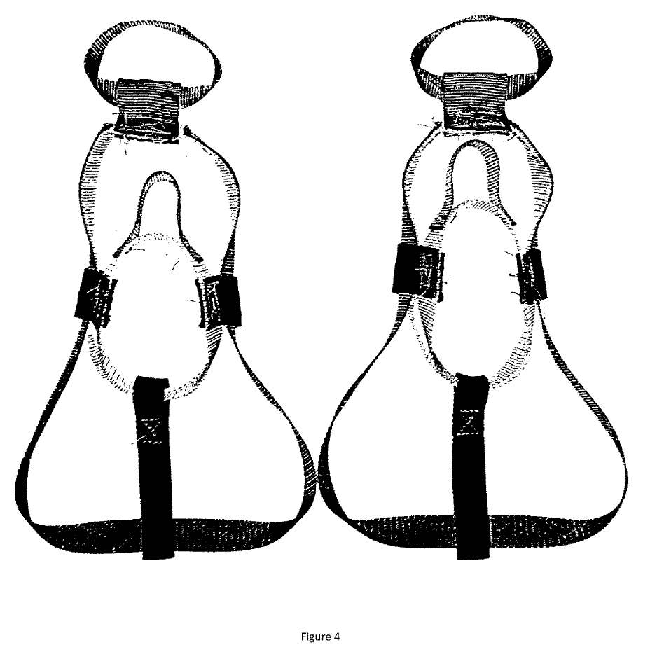

The test model depicted in FIG. 4 uses 2″ width webbing for the connector loop, 1.5″ width for the retainer loops, ¾″ for the mounting loop, and 1″ for all other loop components.

The lengths of webbing required for the primary loop and release loop are scalable, depending on the user's foot size and ankle circumference, though one general device size can accommodate a wide range of users.

Retainer loops are ideally positioned when collinear with the inner and outer talus bone protrusions when the device is closed (fully tensioned) around the lower tibia region.

1. A device, which can suspend a human user by the ankles in an inverted posture, comprising:
a) a primary webbing loop, with a circumference which varies based on applied tension, where the sides intersect at the bottom of said primary loop and ends connect at the top of the device;
b) at least one retainer loop, attached to each side of the primary loop and encircling the opposite, with said retainer loops equidistant from the center-line of the device;
c) a release loop, with ends connected to the top of the primary loop and sides enveloped by the retainer loops, which extends beneath the primary loop;
d) at least one linkage loop, which connects the lowest points of the primary and release loops;
e) a connector loop, which joins the ends of the primary loop; and
f) a mounting loop, linked to the connector loop.

2. The device of claim 1, in which a hardware ring is substituted for the connector loop component.

3. The device of claim 1, in which material sheaths surround webbing regions which are exposed to friction and potential contact abrasion.

4. The device of claim 1, in which a material other than webbing, but with the requisite material properties to conform to the topological configuration described, is used for construction of the whole device or any of its individual components.

5. The device of claim 1, in which the retainer loop component is comprised of multiple segments.

6. The device of claim 1, in which a thumb loop is attached to the primary loop, between the retainer loops, for holding the device in an open position.
